(19) United States
(12) Patent Application Publication
(10) Pub. No.: US 2026/0233142 A1
(43) Pub. Date: Aug. 13, 2026

(54) FILTER SYSTEM AND METHOD FOR PHARMACEUTICAL FILLING ISOLATORS

(71) Applicants: Vanrx Pharmasystems Inc., Burnaby (CA); GLOBAL LIFE SCIENCES SOLUTIONS USA LLC, Marlborough, MA (US)

(72) Inventors: Patrick WONG, Vancouver (CA); Bertille DUPONT, Vancouver (CA)

(73) Assignee: Vanrx Pharmasystems Inc., Burnaby, BC (CA)

(21) Appl. No.: 19/153,431

(22) PCT Filed: Feb. 9, 2024
(86) PCT No.: PCT/US2024/015281

§ 371 Date: Aug. 4, 2025

Related U.S. Application Data
(60) Provisional application No. 63/445,068, filed on Feb. 13, 2023.

(51) Int. Cl. B01D 46/00

(52) U.S. Cl. CPC B01D 46/0005; B01D 46/0091; B01D 2265/025; B01D 2271/022; B01D 2279/65

(57) ABSTRACT

The present invention involves a system and method for mounting an exhaust filter to a pharmaceutical isolator comprises a set of parallel cams joined by a rigid bar to urge a filter carriage containing the filter along a set of parallel spring-loaded linear guide rods. The system engages the exhaust filter under laterally uniform pressure with an exhaust flange of a controlled environment enclosure. In order to ensure that the exhaust filter cannot seal when incorrectly loaded in the filter carriage, an interlock bar obstructs the movement of the filter carriage along the linear guide rods if the exhaust filter is not fully inserted into the filter carriage. The system is employed in a pharmaceutical filling apparatus that has to maintain an aseptic interior environment condition under positive differential pressure.

### CROSS-REFERENCE TO RELATED APPLICATIONS

The present application is a PCT International Patent Application which claims priority under the PCT and 35 U.S.C. § 119(e) of U.S. Provisional Patent Application Ser. No. 63/445,068, filed Feb. 13, 2023, the disclosures of which are incorporated by reference herein.

### FIELD OF THE INVENTION

This present disclosure relates to the medical field as exemplified by IPC class A61 and more particularly to apparatus and associated methods for sterilization of and sterile handling of pharmaceutical materials and containers for pharmaceuticals, including bringing pharmaceuticals into form for administration to medical or veterinary patients. In one aspect, it relates to maintaining proper aseptic conditions in conjunction with the efficient processing with such equipment and systems.

### DESCRIPTION OF RELATED ART

The SARS-COV-2 virus pandemic of the third decade of the twenty-first century has provided a backdrop against which environmental controls on the technological processes of the Pharmaceuticals Industry are tightening. All aspects of the equipment, machines and processes of this industry are now under greater scrutiny. Even for the layman it is becoming clear that what is inside a medical isolator box is of as much importance to the external environment of the isolator, as what the environment itself is to the materials inside the interior of the isolator.

In the field of Pharmaceuticals, the filling of sterile pharmaceutical containers with a pharmaceutical substance is done under carefully controlled sterile or aseptic conditions. The container filling equipment is typically installed and operated in a medical clean laboratory environment that has a controlled atmosphere with exquisitely tightly specified conditions. The United States Food and Drug Administration (FDA) and other international bodies, including the International Standards Organization (ISO), also have well drawn-up and stringent specifications for medical grade isolators containing the filling equipment.

Even though the clean laboratory that houses the filling equipment used in the Pharmaceutical Industry functions under strictly defined conditions, every effort has to be made to ensure that there is no mutual contamination between the interior of the filling apparatus and the clean laboratory environment in which the equipment is housed and operated. To this end, air entering the filling equipment from the clean laboratory environment is filtered.

Similarly, air exiting the equipment to the clean laboratory is also filtered by means of one or more exhaust filters.

In the prior art, the exhaust filters of the filling equipment are typically manually mounted to an exhaust port on a controlled environment enclosure of the equipment. In the Pharmaceutical Industry, the controlled environment enclosures are often referred to as “isolators”. The mounting most typically comprises manually fitting the filter to the exhaust port of the isolator and then tightening a plurality of peripherally arranged bolts or other tightening devices. If the filter is not seated correctly, the exhaust filter or the gasket that seals the exhaust filter to the isolator may be deformed and the fitted and deformed filter may leak. This would typically require the entire operation to be shut down, the filter to be remounted and resealed and the sterile condition in the isolator to be re-established. This form of avoidable downtime has major consequences in an industry that has, based purely on the example of the SARS-COV-2 virus, had to produce billions of doses of vaccines filled into cartridges used in injection needles.

Any steps that can be taken to avoid or shorten interruptions to a pharmaceutical filling process are welcomed by the Pharmaceutical Industry. The present disclosure addresses the matter of ensuring the reliable and correct mounting of exhaust filters to medical isolators.

### SUMMARY OF THE INVENTION

In one aspect, a filter mount system is provided for mounting a filter, the filter having a planar sealing surface perimetrically bounding a porous filter media, in overlying registry with a port of a controlled environment enclosure, wherein the enclosure comprises a flange having a planar sealing surface surrounding the port, the system comprising: a mount frame mounted about the planar sealing surface of the flange; a manually operated single-action actuation subsystem; and a filter carriage for receiving the filter with a planar sealing surface of the filter constrained by the filter carriage to be parallel to the planar sealing surface of the flange. The filter carriage is constrained to translate within the mount frame perpendicular to the planar sealing surface of the flange under the action of the single-action actuation subsystem to effect a sealing engagement of the planar sealing surface of the filter with the planar sealing surface of the flange such that the filter is positioned in overlying registry with the port.

The manually operated single-action actuation subsystem may comprise a plurality of cams disposed to rotate in parallel planes perpendicular to the planar sealing surface of the flange; and a handlebar rigidly connecting the plurality of cams to one another. The cams are arranged to rotate about a common axis in a plane parallel to the planar sealing surface of the flange. The filter carriage may comprise one or more push plates having planar surfaces parallel to the planar sealing surface of the flange. The filter carriage is translatably mounted within the mount frame on a plurality of linear guides extending perpendicular to the planar sealing surface of the flange and slidably extending through the carriage. The plurality of cams is disposed to mechanically act on the one or more push plates to urge the filter carriage along the plurality of linear guides on a path perpendicular to the planar sealing surface of the flange. The linear guides have concentrically mounted compression springs disposed to be compressed as the filter carriage translates on the linear guides toward the planar sealing surface of the flange under the action of the cams on the push plates. The manually operated single-action actuation subsystem effects the sealing engagement of the planar sealing surface of the filter with the planar sealing surface of the flange via one manual partial rotation of the handlebar about the common axis of the cams.

The mount frame may comprise an interlock mechanism arranged to prevent motion of the filter carriage perpendicular to the planar sealing surface of the flange if the filter is incompletely inserted in the filter carriage. The interlock system may comprise an interlock bar having a peg at each longitudinal end; two slots in upper and lower end pieces of the mount frame and extending substantially parallel to the planar sealing surface of the flange. Each peg is attached to the mount frame by an extension spring arranged to retain the interlock bar in a location that obstructs motion of the filter carriage perpendicular to the planar sealing surface of the flange. The two pegs slide in the two slots when the filter is inserted in the filter carriage and the filter pushes the interlock bar out of the location in which the interlock bar obstructs motion of the filter carriage perpendicular to the planar sealing surface of the flange so as to enable sealing engagement by the planar sealing surface of the filter about the port.

The filter mount system may comprise at least two cooperative retention devices disposed on the mount frame and on the manually operated single-action actuation subsystem. The retention devices are arranged to retain the manually operated single-action actuation subsystem in a state in which the planar sealing surface of the filter is sealingly engaged with the planar sealing surface of the flange when the retention devices are mutually engaged. The controlled environment enclosure may a pharmaceutical isolator and the port may be an air exhaust port in fluid communication with a fluid-dispensing interior of the controlled environment enclosure.

In a further aspect, a method is provided for sealing a filter, the filter having a planar sealing surface perimetrically bounding a porous filter media, in overlying registry with a port of a controlled environment enclosure, the method comprising providing a mechanical filter mount system affixed to the enclosure about a planar sealing surface of a flange surrounding the port. The filter mount system comprises a manually operated single-action actuation subsystem and a filter carriage for receiving the filter with a planar sealing surface of the filter constrained by the filter carriage to be parallel to the planar sealing surface of the flange; and the filter carriage is constrained to translate perpendicular to the planar sealing surface of the flange under the action of the single-action actuation subsystem. The filter is inserted into the filter carriage with the planar sealing surface of the filter parallel to the planar sealing surface of the flange such that the filter is positioned in overlying registry with the port and the planar sealing surface of the filter is sealingly engaged with the planar sealing surface of the flange by a single action manually applied to the single-action actuation subsystem.

The manually operated single-action actuation subsystem may comprise a plurality of cams disposed to rotate in parallel planes about a common axis in a plane parallel to the planar sealing surface of the flange and a handlebar rigidly connecting the plurality of cams to one another, so that the single action of the sealing may comprise one manual partial rotation of the handlebar about the common axis of the cams.

The filter mount may comprise an interlock mechanism obstructing the filter carriage in translating perpendicular to the planar sealing surface of the flange and inserting the filter may comprise fully inserting the filter into the filter carriage thereby forcing the interlock mechanism aside to allow the carriage to move.

The filter mount system may comprise at least two cooperative retention devices respectively disposed on a frame of the mount and on the manually operated single-action actuation subsystem and the method may further comprise engaging the retention devices with one another to retain the manually operated single-action actuation subsystem in a state in which the planar sealing surface of the filter is sealingly engaged with the planar sealing surface of the flange.

### BRIEF DESCRIPTION OF DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic drawing of one embodiment of a pharmaceutical filling apparatus comprising a controlled environment enclosure.

FIG. 2 shows a schematic drawing of an exhaust filter suitable for use with the apparatus of FIG. 1.

FIG. 3 is a view of an exhaust filter mount for mounting the exhaust filter of FIG. 2 to the apparatus of FIG. 1.

FIG. 4 shows a view in the opposing direction of the exhaust filter mount of FIG. 3 with the exhaust filter of FIG. 2 mounted in a filter carriage of the exhaust filter mount.

FIG. 5A shows the exhaust filter mount of FIG. 3 with the filter carriage in the retracted position and the filter mount in an open condition.

FIG. 5B shows the exhaust filter mount of FIG. 3 in a closed condition with the filter carriage in a closed position to seal the exhaust filter of FIG. 2 to an exhaust flange of the controlled environment enclosure of FIG. 1.

FIG. 6 is a flow diagram of a method for sealing an exhaust filter to an exhaust flange of a controlled environment enclosure.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The embodiments disclosed below is/are not intended to be exhaustive or limit the invention to the precise form disclosed in the following detailed description. Rather, the embodiment is chosen and described so that others skilled in the art may utilize its teachings.

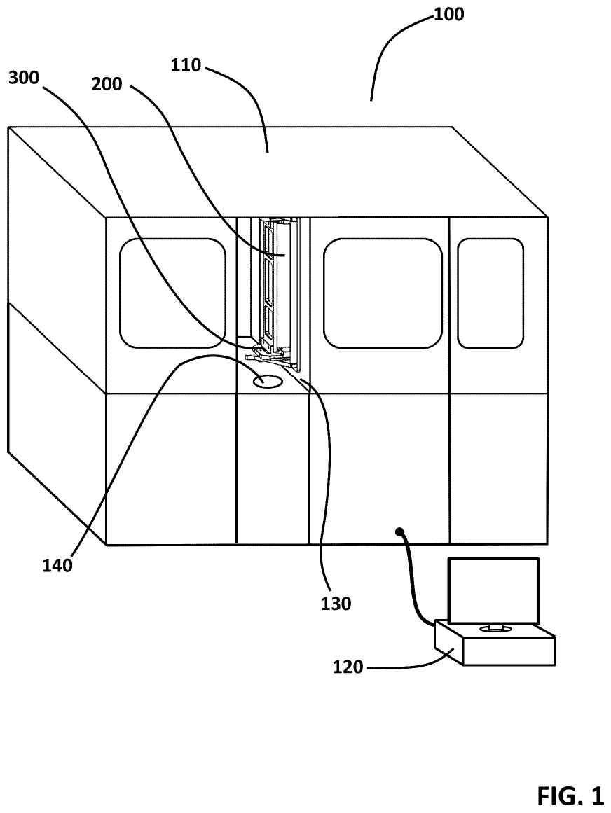

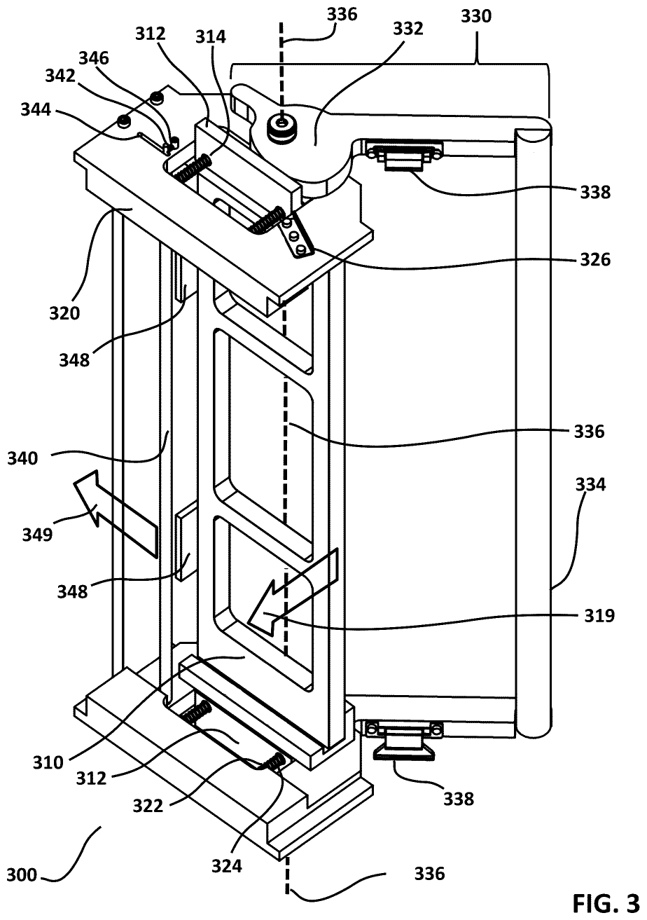

FIG. 1 shows a pharmaceutical filling apparatus 100 comprising a controlled environment enclosure 110. Controlled environment enclosure 110 may be an aseptically sealable medical or pharmaceutical isolator capable of being internally sterilized and capable of maintaining an aseptic condition in its interior. Enclosure 110 may be equipped with an air pressure control subsystem (not shown) for controlling air pressure inside enclosure 110. The air pressure control subsystem may comprise suitable pumps and valves. Suitable pressure control subsystems are well-known to practitioners of the art. Controlled environment enclosure 110 may house various intricate mechanical and servo-mechanical devices used to manipulate pharmaceutical containers and their closures. Enclosure 110 may also house various mechanical and servo-mechanical devices for manipulating at least one pharmaceutical fill needle used for dispensing the pharmaceutical. The pharmaceutical may typically, though not exclusively, be a fluid. Electronic control systems to control or program the activities inside enclosure 110 may also be attached to the exterior of the enclosure. To this end, FIG. 1 shows generic controller 120 connected to enclosure 110 and the various apparatus inside of enclosure 110. Exhaust filter mount 300, described in more detail below with respect to FIGS. 3, 4, and 5A and 5B, seals exhaust filter 200 to a flange surrounding port 150 in enclosure 110 in recessed portion 130 of the exterior of enclosure 110. Exhaust filter 200 is disposed to filter air from enclosure 110 exhausted via port 150. Recessed portion 130 may be closed off with a door (not shown in the interest of clarity). When closed, the door may be shut air-tight to the frame of enclosure 110 so that air exhausted through any filter mounted in exhaust filter mount 300 is vented through vent 140 shown in the base of enclosure 110. Air vented via vent 140 may be recirculated through enclosure 110 via suitable input filters, or may be vented into the clean laboratory environment. Apparatus 100 may comprise a plurality of exhaust filter mounts 300 with filters 200.

The terms “aseptic” and “sterilize” and their derivatives are to be understood as follows for the purposes of the present specification. Establishing an aseptic condition in the interior of an enclosure shall be understood to mean establishing that condition throughout the internal atmosphere of the enclosure as well as on substantially all exposed interior surfaces of the enclosure. This shall include the surfaces of all items, containers, subsystems and the like exposed to the interior atmosphere of the enclosure. To the extent that extremely tight crevices or microscopic crevices may exist in the interior of the enclosure, a sterilizing gas or vapor may not perfectly penetrate into such tight regions. The degree of sterilization in practical cases may therefore not be total. This is acknowledged in both the industry and in the standards set for the industry. The action of establishing an aseptic condition within the interior of the enclosure and “sterilizing the interior of the enclosure” shall have the same meaning in this specification.

Introducing into the interior of an enclosure with an aseptic condition an item of which the surfaces are not suitably sterilized destroys the existing aseptic condition within the enclosure. Conversely, introducing an aseptic or sterilized item into an interior of an enclosure that does not have an aseptic condition within that interior does not render that interior aseptic. In fact, all it does is to destroy the aseptic condition of the surface of the item so introduced. Similarly, introducing filtered air, even with all biological entities filtered out, into an unsterilized enclosure does not in any way sterilize the enclosure or render it aseptic to a degree acceptable in the pharmaceutical industry. The reason is that the interior surfaces of the enclosure are not sterilized by the introduction of such air. All that is achieved is to contaminate the filtered air with active biological species resident on the interior surfaces of the unsterilized enclosure.

In the interest of clarity and completeness, it should also be recorded that in the art the term “aseptic” is also sometimes used in association with the introduction of pharmaceutical fluids along aseptic tubes into bodies within controlled enclosures. In such cases the term in the art refers to the condition inside the tube or to the fact that the pharmaceutical fluid may be filtered to a suitable degree. This in no way sterilizes or renders aseptic the interior of the enclosure in question. The aseptic condition in such cases is confined to the interior of the tube bearing the pharmaceutical stream. Such streams are often filtered to a high degree, but such filtering affects only the interior of the particular tube and does not in any way sterilize the interior of the enclosure.

In some prior art systems, containers introduced into an enclosure for the purposes of being filled with a pharmaceutical are routed through sterilizing subsystems. This kills biological species on the containers. When such sterilized containers are introduced into the enclosure when the enclosure itself is not aseptic the containers lose their aseptic condition, as biological species contained within the enclosure will deposit on the previously aseptic containers.

It should also be pointed out that pharmaceutical or semiconductor clean rooms of any quality level, including “Class 100”, “Class 10” or “Class 1”, even when employing laminar flow hoods and the like or any quality of HEPA (High Efficiency Particulate Air) filters or ULPA (Ultra Low Particulate Air) filters, cannot constitute an aseptic enclosure because they do not have an assurable means to render the surfaces of the room sterile or aseptic. Standards for clean rooms exist from both the United States Food and Drug Administration and ISO (International Standards Organization). These specify in great detail to different standards the allowed particulate content of a cubic volume of air in such a clean room facility. None of these standards address the matter of biological species present on surfaces in the room. This serves to make the point that an enclosure cannot be rendered aseptic by the management of its atmosphere or airflow only. Nor, conversely, can the enclosure be rendered aseptic by the sterilization of only the surfaces of its interior.

The text “Guideline for Disinfection and Sterilization in healthcare Facilities, 2008” by Rutala et al from the Center for Disease Control lists a compendium of mechanisms and methods for sterilization and is hereby incorporated by reference in full as if fully disclosed in the present description. Our concern in this specification is specifically with those mechanisms for sterilizing the interior of an enclosure; that is, sterilizing both the interior surfaces and the atmosphere within the enclosure. Given the requirements, vapor base methods are most appropriate to the task. These include, but are not limited to, treatment with heated water vapor, hydrogen peroxide vapor, ozone, nitrogen dioxide, ethylene oxide, glutaraldehyde vapor or other suitable sterilizing gases and vapors. In one suitable method appropriate to the present invention, the sterilization is by means of hydrogen peroxide vapor which is then flushed using ozone before the enclosure is employed in the filling of pharmaceutical containers.

The term “decontamination” as used herein denotes a process for removing or inactivating contamination, including without limitation viruses, bacteria, spores, prions, molds, yeasts, proteins, pyrogens and endotoxins, to acceptable levels. “Decontamination” as used herein includes both sterilization (that is, the destruction of all microorganisms, including bacterial spores to a probability of surviving organisms of typically less than 1:106) and disinfection (that is, the destruction and removal of specific types of micro-organisms).

To achieve suitable levels of sterilization, enclosure 110 may be hermetically sealed. In one embodiment, the hermetic sealing provided by enclosure 110 is sufficient to satisfy predetermined requirements according to ISO standard ISO10648-2, entitled “Containment Enclosures Part 2—Classification According to Leak Tightness and Associated Checking Methods.” Specifically, the sealing is preferably sufficient to satisfy Class 3, or more preferably Class 2, or even more preferably Class 1. In another embodiment, the hermetic sealing provided by enclosure 100 is sufficient to satisfy predetermined requirements according to PDA Journal of Pharmaceutical Science and Technology Technical Report no. 34, entitled “Design and Validation of Isolator Systems for the Manufacturing and Testing of Health Care Products” (September/October 2001). The disclosures of both of these documents are herein incorporated by reference in full as if fully disclosed herein.

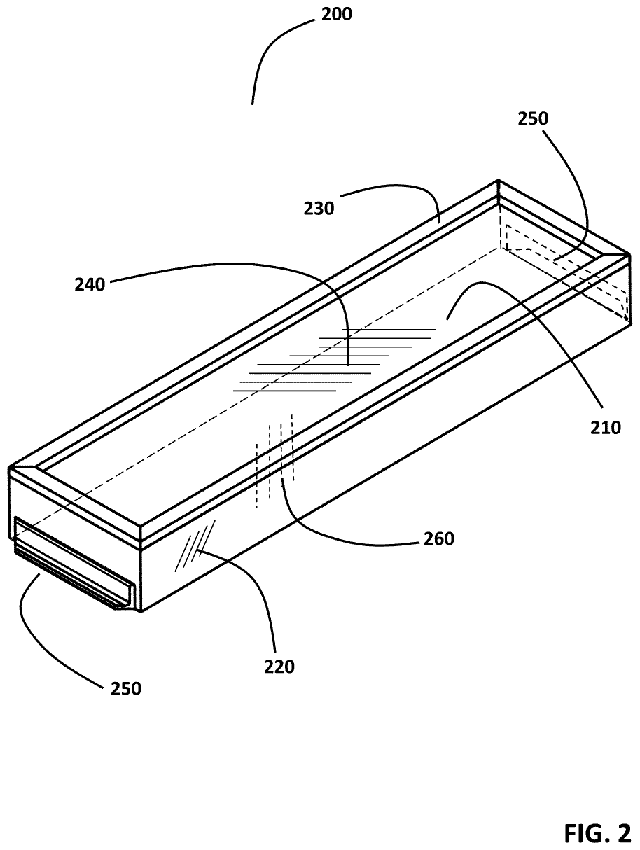

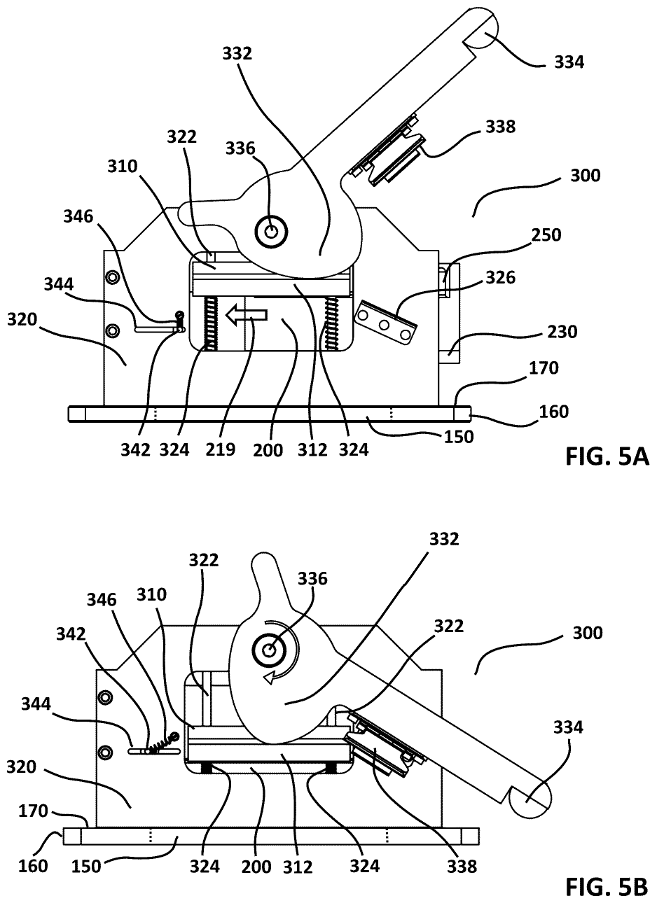

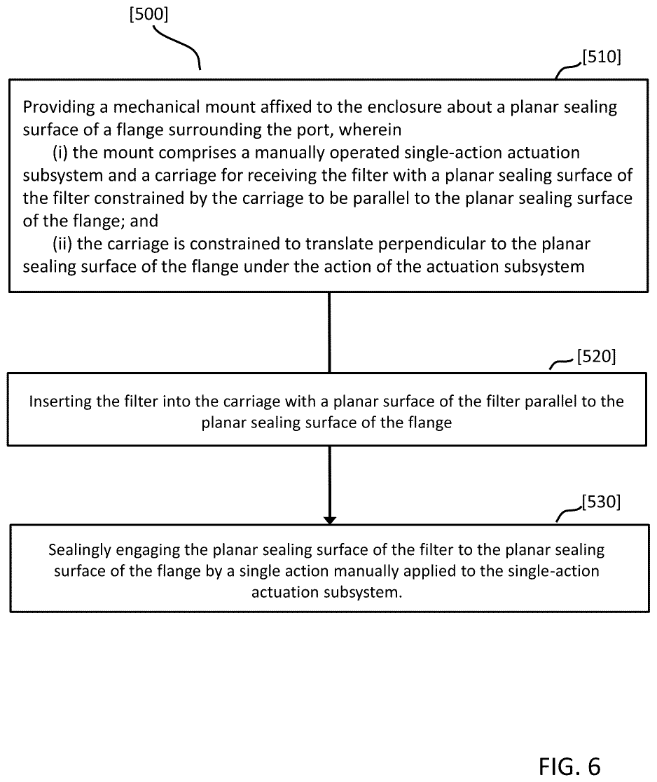

FIG. 2 shows a schematic diagram of exhaust filter 200 suitable for use with apparatus 100. The filter comprises filtering element 210, which may be composed of, for example without limitation, porous PTFE or fiberglass. Filter 200 may further comprise filter frame 220 to house porous filtering element, or media, 210. Compressible gasket 230 is desirably disposed on planar air entrance surface 240 of filtering element 210. Planar air entrance surface 240 is indicated with solid diagonal lines. Gasket 230 perimetrically bounds porous filtering element 210 of filter 200 and forms a planar sealing surface of filter 200. The opposing exterior air exit surface 260 of filter 200 is shown in broken diagonal lines. Two brackets 250 are attached to filter frame 220 at opposing ends of filter frame 220. One of brackets 250, which is located at the distal end of exhaust filter 200, is obscured by filter 200 and is shown in broken lines. Brackets 250 are used to guide exhaust filter 200 when exhaust filter 200 is manually inserted into filter carriage 310 (see FIG. 3 and FIG. 5A).

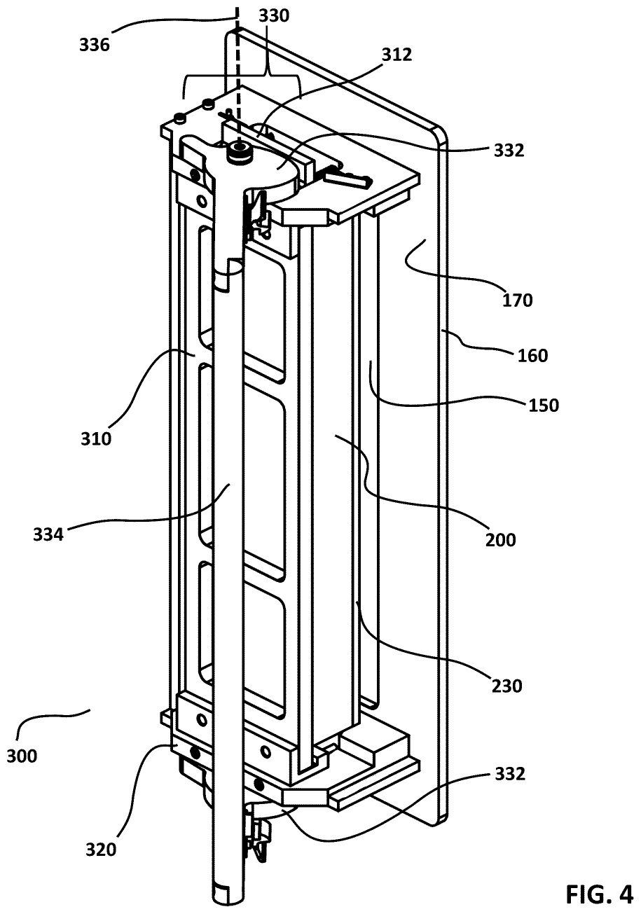

Exhaust filter 200, when mounted to enclosure 110 by means of exhaust filter mount 300, is disposed to be in overlying registry with port 150, gasket 230, being the planar sealing surface of filter 200, sealingly engaging with planar sealing surface 170 of flange 160 (see FIG. 4), so as to expose air entrance surface 240 to the interior of enclosure 110 and thereby to the heated water vapor, hydrogen peroxide vapor, ozone, nitrogen dioxide, ethylene oxide, glutaraldehyde vapor or other suitable sterilizing gases and vapors employed in sterilizing the interior of enclosure 110, as described above. Filter 200 therefore has to be compatible with these gases and vapors and the processes for employing them. In the embodiment shown in FIG. 2, exhaust filter 200 is shown as having a rectangular shape. In other embodiments, the exhaust filter may have a variety of other suitable shapes, including without limitation, a circular shape.

FIG. 3 shows exhaust filter mount 300 in more detail with exhaust filter 200 absent. The entire exhaust filter mount 300 may be attached permanently to the exterior of enclosure 110 within recessed portion 130 of the exterior of enclosure 110. In one embodiment, shown in FIG. 1, exhaust filter mount 300 is disposed with its longest dimension arranged vertically. In other embodiments exhaust filter mount 300 may be arranged in other orientations that allow gasket 230 to sealingly engage with exhaust flange 160 of the exterior surface of enclosure 110. For a detail view of exhaust flange 160, see FIGS. 4, 5A and 5B described below.

When the door (not shown) to recessed portion 130 of the exterior of enclosure 110 is closed, exhaust air being exhausted from enclosure 110 via exhaust filter 200 is evacuated via vent 140. The filtering action of exhaust filter 200 occurs in this process.

Exhaust filter mount 300 comprises movable filter carriage 310. Filter carriage 310 comprises two push plates 312 at either of its longitudinal ends, both arranged to move along a plurality of linear guides 322 within mount frame 320 of exhaust filter mount 300 whilst compressing a corresponding plurality of springs 324 disposed concentrically on corresponding linear guides 322. In FIG. 3, four linear guides 322 are shown, each with one spring 324 arranged concentrically around it. In the interest of clarity, only one linear guide 322 and its corresponding spring 324 is labeled at the bottom of mount frame 320. Linear guides 322 and springs 324 may be seen in more detail in FIGS. 5A and 5B.

Filter carriage 310 is urged along its path of motion along linear guides 322 within mount frame 320 by cam subsystem 330, comprising two cams 332 rigidly joined together rigidly by rigid handlebar 334. Cam subsystem 330 is herein described as a “manually operated single-action actuation subsystem”. One of cams 332 connected to handlebar 334 is not visible in FIG. 3 as it is obscured by portions of mount frame 320. Each of cams 332 rotate about cam axis 336 parallel to handlebar 334. Cam axis 336 is parallel to the planar sealing face (gasket 230 in the case of the filter of FIG. 2) of exhaust filter 200 when exhaust filter 200 is mounted in exhaust filter mount 300. Cam axis 336 is thus also parallel to exhaust flange 160 shown in FIGS. 5A and 5B described below. FIGS. 3, 4, 5A and 5B show different views of cams 332 acting on push plates 312. Push plates 312 are provided with suitable holes 314 arranged for sliding along linear guides 322 and are disposed to compress springs 324 under the action of cams 332.

FIG. 4 shows a view of exhaust filter mount 300 in the opposing direction from that of FIG. 3, with exhaust filter 200 mounted in filter carriage 310 of exhaust filter mount 300. In FIG. 4, gasket 230 of exhaust filter 200 is facing away from the viewer. This view of exhaust filter mount 300 shows both cams 332. However, linear guides 322 and springs 324 are obscured in this view. FIG. 4 also shows port 150 of enclosure 110 surrounded by flange 160, which has planar sealing surface 170 to which filter 200 is configured to seal.

FIG. 5A shows a top-down view of exhaust filter mount 300 with filter carriage 310 retracted away from exhaust flange 160 around port 150. Springs 324 around linear guides 322 are relaxed. Exhaust filter 200 is shown not fully inserted in filter carriage 310. FIG. 5B shows the same view of exhaust filter mount 300 with filter carriage 310 in the closed position in which springs 324 around linear guides 322 are compressed. Exhaust filter 200 is in a clamped condition, being under pressure to seal to exhaust flange 160 of enclosure 110. Port 150 of enclosure 110 is shown in broken lines in both FIG. 5A and FIG. 5B.

Handlebar 334 may be rotated (anti-clockwise in FIGS. 5A and 5B) about cam axis 336 to retract filter carriage 310 in order to thereby move exhaust filter 200 away from exhaust flange 160 of enclosure 110. This would typically be done to replace exhaust filter 200 in filter carriage 310. To seal exhaust filter 200 to enclosure 110, handlebar 334 may be rotated in the opposing sense (clockwise in FIG. 5B). This rotation would urge filter carriage 310 along the plurality of linear guides 322 whilst compressing springs 324. This action may continue until gasket 230 seals with exhaust flange 160. Springs 324 may be arranged such that, when gasket 230 has sealed to the exterior of enclosure 110, springs 324 are compressed enough to produce a force that is sufficient to force gasket 230 away from exhaust flange 160. For this reason, cooperative retention devices 326 and 338, as shown in FIG. 3, may be disposed on mount frame 320 and on cam subsystem 330 respectively to keep cam subsystem 330 in the closed position and exhaust filter 200 thereby sealed to the exterior of enclosure 110 when apparatus 100 is in use. In FIG. 3, cooperative retention devices 326 and 338 form between them an elbow latch. In other embodiments, alternative retention devices may be employed. The retention device of elements 326 and 338 may be released to rotate handlebar 334 to the open position to thereby move filter carriage 310 and exhaust filter 200 away from exhaust flange 160 in order to facilitate removal of exhaust filter 200.

The arrangement of exhaust filter mount 300 and its specific mode of functioning allows exhaust filter 200, mounted in filter carriage 310, to be sealingly engaged with exhaust flange 160 of the exterior of enclosure 110 with equalized pressure over the entire surface of gasket 230 that serves as planar sealing surface for filter 200. This apparatus, mechanism and method effectively counter the leakage problems associated with the prior art manual mounting of exhaust filters.

Pharmaceutical filling apparatus 100 is configured to not turn on the servomechanical filling apparatus in enclosure 110 unless a positive atmospheric pressure is detected in the enclosure as compared with the exterior environment surrounding the apparatus 100. To this end exhaust filter mount 300 may be equipped with an interlock mechanism. In the embodiment of FIGS. 3, 4, 5A and 5B, exhaust filter mount 300 has interlock bar 340 engaged with mount frame 320 and arranged to ensure that exhaust filter 200 cannot be sealingly engaged with exhaust flange 160 of enclosure 110 to establish that positive differential pressure unless interlock bar 340 is suitably positioned. Interlock bar 340, in turn, cannot be placed in the required position unless exhaust filter 200 is fully and correctly inserted in filter carriage 310.

Interlock bar 340 obstructs the path of filter carriage 310 along the plurality of linear guides 322 unless exhaust filter 200 is fully inserted into filter carriage 310. With the path of filter carriage 310 thus obstructed, exhaust filter 200 cannot seal to exhaust flange 160 of enclosure 110, a positive pressure cannot be established in enclosure 110, and the entire apparatus 100 cannot turn on electrically.

To this end, interlock bar 340 comprises two pegs 342 with one peg 342 at either longitudinal end of interlock bar 340, each peg 342 extending in the longitudinal direction from its respective end of interlock bar 340, each peg 342 thereby extending along the same longitudinal axis. Pegs 342 slide in corresponding two slots 344, one slot 344 being arranged at either longitudinal end of mount frame 320. Slots 344 map exactly onto each other along the longitudinal axis of mount frame 320. Each of pegs 342 is provided with extension spring 346 attached to corresponding fixed points on the corresponding longitudinal ends of mount frame 320. Springs 346 are therefore disposed to ensure that interlock bar 340 obstructs the path of filter carriage 310 along the plurality of linear guides 322, unless exhaust filter 200 is fully inserted into filter carriage 310. In FIG. 5A, interlock bar 340 (obscured by mount frame 320 in this view, but shown in FIG. 3) has not yet been engaged and corresponding peg 342 is therefore still at its extreme rightmost location in slot 344. Spring 346 is shown in a commensurately relaxed state. When exhaust filter 200 is fully inserted in filter carriage 310, it stops against stops 348 on filter carriage 310. Before reaching stops 348, exhaust filter 200 pushes against interlock bar 340 and thereby urges interlock bar 340 in a lateral direction indicated by arrow 349 in FIG. 3. Slots 344 are arranged to have lengths that allow exhaust filter 200 to push interlock bar 340 completely out of the way of filter carriage 310, allowing thereby filter carriage 310 to progress in the direction of arrow 319 in FIG. 3 in order to seal exhaust filter 200 to planar sealing surface 170 of exhaust flange 160 of enclosure 110.

The above description provides filter mount system 300 for mounting filter 200, filter 200 having planar sealing surface in the form of gasket 230 perimetrically bounding porous filter media 210, in overlying registry with port 150 of a controlled environment enclosure 110, wherein enclosure 110 comprises flange 160 having planar sealing surface 170 surrounding port 150, filter mount system 300 comprising: mount frame 320 mounted about planar sealing surface 170 of flange 160; manually operated single-action actuation subsystem 330; and filter carriage 310 for receiving filter 200 with planar sealing surface, in the form of gasket 230, of filter 200 constrained by filter carriage 310 to be parallel to planar sealing surface 170 of flange 160, wherein filter carriage 310 is constrained to translate within mount frame 320 perpendicular to planar sealing surface 170 of flange 160 under the action of single-action actuation subsystem 330 to effect a sealing engagement of planar sealing surface (gasket 230) of filter 200 with planar sealing surface 170 of flange 160 such that filter 200 is positioned in overlying registry with port 150.

Manually operated single-action actuation subsystem 330 may comprise a plurality of cams 332 disposed to rotate in parallel planes perpendicular to planar sealing surface 170 of flange 160; and handlebar 334 rigidly connecting the plurality of cams 332 to one another, wherein cams 332 are arranged to rotate about a common axis in a plane parallel to planar sealing surface 170 of flange 160. Filter carriage 310 may comprise one or more push plates 312 having planar surfaces parallel to planar sealing surface 170 of flange 160. Filter carriage 310 is translatably mounted within mount frame 320 on a plurality of linear guides 322 extending perpendicular to planar sealing surface 170 of flange 160 and slidably extending through filter carriage 310 and the plurality of cams 332 is disposed to mechanically act on the one or more push plates 312 to urge filter carriage 310 along the plurality of linear guides 322 on a path perpendicular to planar sealing surface 170 of flange 160. Linear guides 322 have concentrically mounted compression springs 324 disposed to be compressed as filter carriage 310 translates on linear guides 322 toward planar sealing surface 170 of flange 160 under the action of cams 332 on push plates 312. Manually operated single-action actuation subsystem 330 effects the sealing engagement of planar sealing surface of filter 200 with planar sealing surface 170 of flange 160 via one manual partial rotation of handlebar 334 about common axis 336 of cams 332.

The mount frame 320 may comprise an interlock mechanism (elements 340, 342, 344 and 346 of FIG. 3 and FIGS. 5A and 5B) arranged to prevent motion of filter carriage 310 perpendicular to planar sealing surface 170 of flange 160 if filter 200 is incompletely inserted in filter carriage 310. The interlock system may comprise interlock bar 340 having one peg 342 at each longitudinal end; slots 344 in upper and lower end pieces of mount frame 320 and extending substantially parallel to planar sealing surface 170 of flange 160, wherein each peg 342 is attached to mount frame 320 by extension spring 346 arranged to retain interlock bar 340 in a location that obstructs motion of filter carriage 310 perpendicular to planar sealing surface 170 of flange 160. Pegs 342 slide in each of slots 344 when filter 200 is inserted in filter carriage 310 and filter 200 pushes interlock bar 340 out of the location in which interlock bar 340 obstructs motion of filter carriage 310 perpendicular to planar sealing surface 170 of flange 160 so as to enable sealing engagement by planar sealing surface (gasket 230) of filter 200 about port 150.

Filter mount system 300 may comprise at least two cooperative retention devices 326 and 338 disposed respectively on mount frame 320 and on manually operated single-action actuation subsystem 330, retention devices 326 and 338 being arranged to retain manually operated single-action actuation subsystem 330 in a state in which planar sealing surface (being gasket 230) of filter 200 is sealingly engaged with planar sealing surface 170 of flange 160 when retention devices 326 and 338 are mutually engaged. Controlled environment enclosure 110 may be a pharmaceutical isolator and port 150 may be an air exhaust port in fluid communication with a fluid-dispensing interior of the controlled environment enclosure.

In one aspect, method [500] is provided for sealing filter 200, the filter having planar sealing surface (gasket 230) perimetrically bounding porous filter media 210, in overlying registry with port 150 of controlled environment enclosure 110, the method comprising: providing [510] mechanical filter mount system 300 affixed to enclosure 110 about planar sealing surface 170 of flange 160 surrounding port 150, wherein filter mount system 300 may comprise manually operated single-action actuation subsystem 330 and filter carriage 310 for receiving filter 200 with planar sealing surface (such as gasket 230) of filter 200 constrained by filter carriage 310 to be parallel to planar sealing surface 170 of flange 160 and filter carriage 310 may be constrained to translate perpendicular to planar sealing surface 170 of flange 160 under the action of single-action actuation subsystem 330; [520] inserting filter 200 into filter carriage 310 with planar sealing surface (gasket 230) of filter 200 parallel to planar sealing surface 170 of flange 160 such that the filter is positioned in overlying registry with the port; and sealingly engaging [530] planar sealing surface (gasket 230) of filter 200 to planar sealing surface 170 of flange 160 by single action manually applied to the single-action actuation subsystem 330.

Manually operated single-action actuation subsystem 330 may comprise a plurality of cams 332 disposed to rotate in parallel planes about common axis 336 in a plane parallel to planar sealing surface 170 of flange 160 and handlebar 334 rigidly connecting the plurality of cams 332 to one another, so that the single action of sealing [520] may comprise one manual partial rotation of handlebar 334 about common axis 336 of cams 332.

Filter mount system 300 may comprise an interlock mechanism obstructing the filter carriage in translating perpendicular to planar sealing surface 170 of flange 160 and inserting filter 200 may comprise fully inserting filter 200 into filter carriage 310 thereby forcing the interlock mechanism aside to allow filter carriage 310 to move.

Filter mount system 300 may comprise at least two cooperative retention devices 338 and 326 respectively disposed on frame 320 of mount 300 and on manually operated single-action actuation subsystem 330 and method [500] may further comprise engaging retention devices 338 and 326 with one another to retain manually operated single-action actuation subsystem 330 in a state in which planar sealing surface (gasket 230) of filter 200 is sealingly engaged with planar sealing surface 170 of flange 160.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A filter mount system for mounting a filter, the filter having a planar sealing surface perimetrically bounding a porous filter media, in overlying registry with a port of a controlled environment enclosure, wherein the enclosure comprises a flange having a planar sealing surface surrounding the port, the mount system comprising:
a mount frame mountable about the planar sealing surface of the flange;
a manually operated single-action actuation subsystem; and
a filter carriage for receiving the filter with the planar sealing surface of the filter constrained by the filter carriage to be parallel to the planar sealing surface of the flange,
wherein the filter carriage is constrained to translate within the mount frame perpendicular to the planar sealing surface of the flange under the action of the single-action actuation subsystem to effect a sealing engagement of the planar sealing surface of the filter with the planar sealing surface of the flange such that the filter is positioned in overlying registry with the port.

2. The filter mount system of claim 1, wherein the single-action actuation subsystem comprises:
a plurality of cams disposed to rotate in parallel planes perpendicular to the planar sealing surface of the flange; and
a handlebar rigidly connecting the plurality of cams to one another, wherein the cams are arranged to rotate about a common axis in a plane parallel to the planar sealing surface of the flange.

3. The filter mount system of claim 2, wherein:
the filter carriage comprises one or more push plates having planar surfaces parallel to the planar sealing surface of the flange;
the filter carriage is translatably mounted within the mount frame on a plurality of linear guides extending perpendicular to the planar sealing surface of the flange and the linear guides slidably extending through the filter carriage; and
the plurality of cams is disposed to mechanically act on the one or more push plates to urge the filter carriage along the plurality of linear guides on a path perpendicular to the planar sealing surface of the flange.

4. The filter mount system of claim 3, wherein the linear guides have concentrically mounted compression springs disposed to be compressed as the filter carriage translates on the linear guides toward the planar sealing surface of the flange under the action of the cams on the push plates.

5. The filter mount system of claim 2, wherein the manually operated single-action actuation subsystem effects the sealing engagement of the planar sealing surface of the filter with the planar sealing surface of the flange via one manual partial rotation of the handlebar about the common axis of the cams.

6. The filter mount system of claim 1, wherein the mount frame comprises an interlock mechanism arranged to prevent motion of the filter carriage perpendicular to the planar sealing surface of the flange if the filter is incompletely inserted in the filter carriage.

7. The filter mount system of claim 5, wherein the interlock mechanism comprises:
an interlock bar having a peg at each longitudinal end;
two slots in upper and lower end pieces of the mount frame and extending substantially parallel to the planar sealing surface of the flange; and
wherein each peg is attached to the mount frame by an extension spring arranged to retain the interlock bar in a location that obstructs motion of the filter carriage perpendicular to the planar sealing surface of the flange; and
wherein the two pegs slide in the two slots when the filter is inserted in the filter carriage and the filter pushes the interlock bar out of the location in which the interlock bar obstructs motion of the filter carriage perpendicular to the planar sealing surface of the flange so as to enable sealing engagement by the planar sealing surface of the filter about the port.

8. The filter mount system of claim 1, wherein the system comprises at least two cooperative retention devices disposed on the mount frame and on the single-action actuation subsystem, the retention devices being arranged to retain the single-action actuation subsystem in a state in which the planar sealing surface of the filter is sealingly engaged with the planar sealing surface of the flange when the retention devices are mutually engaged.

9. The filter mount system of claim 1, wherein the controlled environment enclosure is a pharmaceutical isolator and the port is an air exhaust port in fluid communication with a fluid-dispensing interior of the controlled environment enclosure.

10. A method for sealing a filter, the filter having a planar sealing surface perimetrically bounding a porous filter media, in overlying registry with a port of a controlled environment enclosure, the method comprising:
providing a filter mount system affixed to the enclosure about a planar sealing surface of a flange surrounding the port, wherein
the filter mount system comprises a manually operated single-action actuation subsystem;
the filter mount system comprises a filter carriage for receiving the filter with a planar sealing surface of the filter constrained by the carriage to be parallel to the planar sealing surface of the flange; and
the filter carriage is constrained to translate perpendicular to the planar sealing surface of the flange under the action of the single-action actuation subsystem;
inserting the filter into the filter carriage with the planar sealing surface of the filter parallel to the planar sealing surface of the flange such that the filter is positioned in overlying registry with the port; and
sealingly engaging the planar sealing surface of the filter to the planar sealing surface of the flange by a single action manually applied to the single-action actuation subsystem.

11. The method of claim 10, wherein the manually operated single-action actuation subsystem comprises:
a plurality of cams disposed to rotate in parallel planes about a common axis in a plane parallel to the planar sealing surface of the flange; and
a handlebar rigidly connecting the plurality of cams to one another; and
wherein the single action comprises rotating the handlebar in one manual partial rotation about the common axis of the cams.

12. The method of claim 10, wherein
the filter mount system comprises an interlock mechanism obstructing the filter carriage in translating perpendicular to the planar sealing surface of the flange; and
the inserting the filter comprises fully inserting the filter into the filter carriage thereby forcing the interlock mechanism aside to allow the filter carriage to move.

13. The method of claim 10, wherein
the filter mount system comprises at least two cooperative retention devices disposed on a frame of the mount and on the manually operated single-action actuation subsystem; and
wherein the method further comprises engaging the retention devices with one another to retain the manually operated single-action actuation subsystem in a state in which the planar sealing surface of the filter is sealingly engaged with the planar sealing surface of the flange.

14. The method of claim 10, wherein the controlled environment enclosure is a pharmaceutical isolator.

15. The method of claim 10, wherein the port is an exhaust port in fluid communication with an of the controlled environment enclosure.
